(19) United States
(12) Patent Application Publication
(10) Pub. No.: US 2023/0185855 A1
(43) Pub. Date: Jun. 15, 2023

(54) LOG DATA MANAGEMENT

(71) Applicant: VMWARE, INC., Palo Alto, CA (US)

(72) Inventors: KARTHIK SESHADRI, Bangalore (IN); RADHAKRISHNAN DEVARAJAN, Bangalore (IN); SHIVAM SATIJA, Bangalore (IN); SIDDARTHA LAXMAN KARIBHIMANVAR, Bangalore (IN); RACHIL CHANDRAN, Bangalore (IN)

(21) Appl. No.: 17/592,532

(22) Filed: Feb. 4, 2022

(30) Foreign Application Priority Data
Dec. 9, 2021 (IN) 202141057212

(51) Int. Cl. G06F 16/903

(52) U.S. Cl. CPC G06F 16/90335

(57) ABSTRACT

This disclosure relates generally to efficiently storing and retrieving indexless log data. In particular, during ingestion of the log data metadata describing the log data and its location within a first data storage system is saved in a second data storage system to assist in efficient retrieval of the log data.

### RELATED APPLICATION

Benefit is claimed under 35 U.S.C. 119(a)-(d) to Foreign Application Serial No. 202141057212 filed in India entitled “LOG DATA MANAGEMENT”, on Dec. 9, 2021, by VMware, Inc., which is herein incorporated in its entirety by reference for all purposes.

### FIELD

The present disclosure relates generally to methods and systems for improving the efficiency of log data retrieval. In particular, a log management system that leverages metadata stored during log data ingest to assist in the efficient retrieval of indexless log data is disclosed.

### BACKGROUND

Log data storage and retrieval is critical to the management and monitoring of complex computing systems as it allows for computing system optimizations based on analysis of current and past operations. While storage of log data in the cloud is feasible, access times and/or costs associated with accessing the log data from the cloud tends to make storage of the log data in the cloud undesirable for some use cases. For example, accessing large volumes of data on cloud storage at reasonable speeds can result in the accrual of substantial access fees. For this reason, methods for improving access to large volumes of log data are desirable.

### SUMMARY

This disclosure describes methods for optimizing the storage and retrieval of log data.

A non-transitory computer-readable storage medium is disclosed. Instructions stored within the computer-readable storage medium are configured to be executed by one or more processors to carry out steps that include: receiving a request to retrieve log data from a first data storage system containing a plurality of log data files; identifying a subset of the plurality of log data files that contain the requested log data by sending the request to a second data storage system, separate and distinct from the first data storage system, that runs a log data indexing service and stores metadata describing contents of the plurality of log data files stored in the first data storage system; transmitting a query to the first data storage system with instructions to search only the subset of the plurality of log data files for the requested log data; and receiving the requested log data from the first data storage system.

A log data retrieval system is disclosed. The log data retrieval system includes the following: one or more processors; and memory storing one or more programs configured to be executed by the one or more processors, the one or more programs including instructions for: receiving a request to retrieve log data from a first data storage system containing a plurality of log data files; identifying a subset of the plurality of log data files that contain the requested log data by sending the request to a second data storage system, separate and distinct from the first data storage system, that runs a log data indexing service and stores metadata describing contents of the plurality of log data files stored in the first data storage system; transmitting a query to the first data storage system with instructions to search only the subset of the plurality of log data files for the requested log data; and receiving the requested log data from the first data storage system.

A method of retrieving data from a log data storage system is disclosed. The method includes at least the following: receiving a request to retrieve log data from a first data storage system containing a plurality of log data files; identifying a subset of the plurality of log data files that contain the requested log data by sending the request to a second data storage system, separate and distinct from the first data storage system, that runs a log data indexing service and stores metadata describing contents of the plurality of log data files stored in the first data storage system; transmitting a query to the first data storage system with instructions to search only the subset of the plurality of log data files for the requested log data; and receiving the requested log data from the first data storage system.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 shows a computing architecture in which computing systems are responsible for sending log data to log data storage for storage.

FIG. 2 shows a block diagram illustrating a system for receiving and processing log data prior to storing the log data at log storage.

FIG. 3A shows a graphical representation of a hierarchical index/metadata structure 300 that could be formed and stored within log data indexing service 214 during a data log ingest process.

FIG. 3B shows how in some embodiments, data files can be grouped/partitioned based on customer defined query conditions before persisting the log data files to log storage.

FIG. 4 shows a log data retrieval system for querying indexless log data log data stored on a data storage system.

FIG. 5 shows a flow diagram illustrating a process for efficiently querying indexless log data.

### DETAILED DESCRIPTION

Certain details are set forth below to provide a sufficient understanding of various embodiments of the invention. However, it will be clear to one skilled in the art that embodiments of the invention can be practiced without one or more of these particular details. Moreover, the particular embodiments of the present invention described herein are provided by way of example and should not be used to limit the scope of the invention to these particular embodiments. In other instances, hardware components, network architectures, and/or software operations have not been shown in detail in order to avoid unnecessarily obscuring the invention.

Log data storage and retrieval is critical to the management and monitoring of complex computing systems. Log data is typically not stored in an indexless state since any searches for data would have to be performed in a brute force manner that would make retrieval of the indexless log data slow and potentially costly. While cloud storage services have become increasingly prevalent in industry, retrieval of the log data can be costly when performed at scale.

One solution to this issue is to store the log data on a data storage system of the cloud storage service without also storing indexing information for the log data on the same data storage system. Storing the log data without an index allows for a large increase in the amount of compression that can be applied to the log data since storing the indexes with the log data would prevent or seriously reduce the amount of compression that could be applied to the log data. Compression is generally incompatible with indexes because the indexes need to operate in an uncompressed state in order to allow for their proper operation.

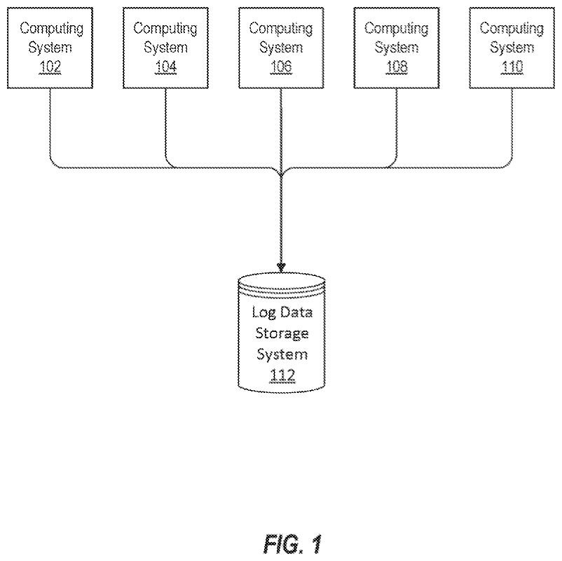

These and other embodiments are discussed below with reference to FIGS. 1-5. Those skilled in the art, however, will readily appreciate that the detailed description given herein with respect to these figures is for explanatory purposes only and should not be construed as limiting.

FIG. 1 shows a computing architecture 100 in which each of computing systems 102-110 are responsible for sending log data to log data storage 112 for long or short-term storage. Log data generally takes the form of log entries generated by a computing system that describe routine or abnormal events occurring on a respective computing system. Each of computing systems 102-110 can represent a standalone computing device or a distributed computing system. In some embodiments, log data can be retained on a computing system that generated it for a predetermined amount of time but offloading the log data is fairly standard since it generally takes up substantial amounts of storage space as it accumulates over time. Log data storage system 112 can take the form of large storage arrays housed on the premises of a large corporation and/or cloud storage hosted on a cloud provider such as AWS, Azure, Google Cloud Platform, IBM Cloud, Oracle Cloud Infrastructure, etc.

As depicted in FIG. 1, the flow of log data from computing systems 102-108 is generally from the respective computing system to log data storage system 112. However, a computing system can include functionality that allows for the submission of queries to log data storage system 112 when information about historical events is desired in which case information from one or more log entries flows from log data storage system 112 back to the requesting computing system. Log data storage systems generally include some kind of index and/or metadata that assists in the retrieval of log data from log data storage system 112 during a query. For example, the index can be configured to assist in identifying log data files containing log entries describing events that occurred within a particular range of dates or times. Unfortunately, since indexes can't generally be compressed without compromising their ability to assist in log queries, the indexes often add substantially to the space required to store the log data. It should be appreciated that while log data storage system 110 is depicted as a single module in FIG. 1, additional supporting infrastructure can make up log data storage system 110 to assist in the storage and/or retrieval of the log data.

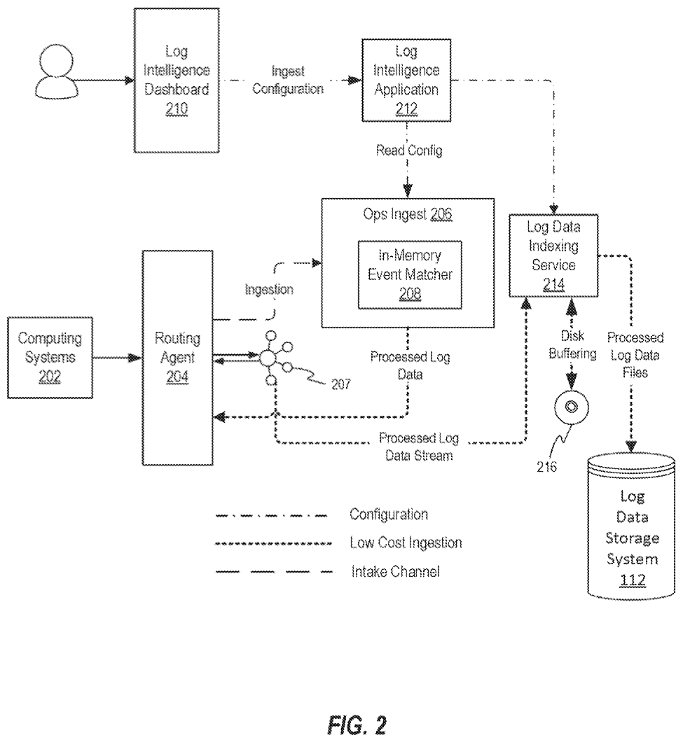

FIG. 2 shows a block diagram illustrating a system 200 for receiving and processing log data prior to storing the log data at log data storage system 112. Computing systems 202, which can represent computing systems 102-110 from FIG. 1, supply log data to a routing agent 204. Routing agent 204 is configured to concurrently route the incoming log data to ops-ingest 206 and to KAFKA service 207. In some embodiments, routing agent 204 can take the form of a Lemans routing agent. While the implementation of a KAFKA service is describe herein, it should be appreciated that other types of stream processing services could be used in lieu of

KAFKA service 207 and this example should not be construed as limiting. Ops-ingest 206 is configured to read and/or process incoming log data from routing agent 204. Processing the data generally includes passing the raw log data through a chain of transformers for ELT (Extraction, Loading, Transformation) processing. One of the tasks accomplished by the processing can be to unify a format of the log data as different computing systems of computing systems 202 can output raw log data in different formats. The processing can also be configured to perform other tasks such as the removal of invalid, undesired or confidential values from particular log entries. Ops-ingest 206 can include an in-memory matcher 208 configured to identify and/or tag event data from any log data during processing that corresponds to particular events of interest. Ops-ingest is also generally responsible for determining whether a subset of the incoming log data containing a particular log event or series of log events should also be saved in a rapid access cloud storage location or in a server owned by the entity running the servers generating the log data. KAFKA service 207 can be configured to extract some of the data from the raw stream of log data to feed real-time dashboards, alert services or other data driven applications. It should be appreciated that KAFKA service 207 can include a separate output for log data used to feed the real-time dashboards, alert services or other data driven applications identified by in-memory event matcher 208. In addition to feeding the stream of log data to feed other services, KAFKA service 207 can also be used to process and transmit a stream of log data processed by ops-ingest 206 to log data indexing service 214.

In-memory event matcher 208 can be configured using log intelligence dashboard 210, where an administrator is able to specify events of interest to identify from the log data and other instructions for ingest. These events of interest can be included as part of an ingest configuration that is received at log intelligence application 212 and log data indexing service 214. The ingest configuration can also include instructions for how processed unindexed log data files are organized. In some embodiments, the instructions specify groupings of particular types of log entries into corresponding log data files. For example, all log entries associated with software development environments can be grouped in a first data file while all log entries associated with operational environments can be grouped in a second data file. This type of grouping can be specified in the ingest configuration and can reduce a number of log data files that need to be searched when a query specifies a search for log entries associated only with a particular environment.

Processed log data leaving ops-ingest 206 returns to routing agent 204 where it is rerouted back to log data indexing service 214 as a stream of log entries. In some embodiments, a speed at which routing agent 204 forwards the stream of log entries to log data indexing service 214 can be optimized to correspond to a rate at which log data indexing service 214 is able to process an incoming stream of log entries. As the log entries are received at log data indexing service 214 the log entries are stored temporarily on a local storage 216. Once the log entries stored on local storage 216 reach a predetermined size (e.g. 5-10 GB), log data indexing service creates a log data file with at least a portion of the log entries stored on local storage 216. Log data indexing service retains an index that includes metadata describing the contents of the created log data file. The metadata generally includes file size, time range, a URI where the log data file can be accessed within the target data storage system and other information that helps in querying the log data file later. In some embodiments, the metadata can also describe other attributes of the log data file. For example, an ingest configuration can specify that individual log data files be limited to specific types of data. For example, log data indexing service 214 can be configured to combine log entries from a single computing system or from a single group of computing systems, resulting in some log data files including only log entries of one or more specific types. A system capable of grouping log entries in this way can need a larger local storage 216 as it can take more disk space to store log entries before enough log entries of a particular type are received to reach the predetermined size. The predetermined size is specified since it is typically more expensive to save a larger number of files of smaller size than an equivalently sized single file.

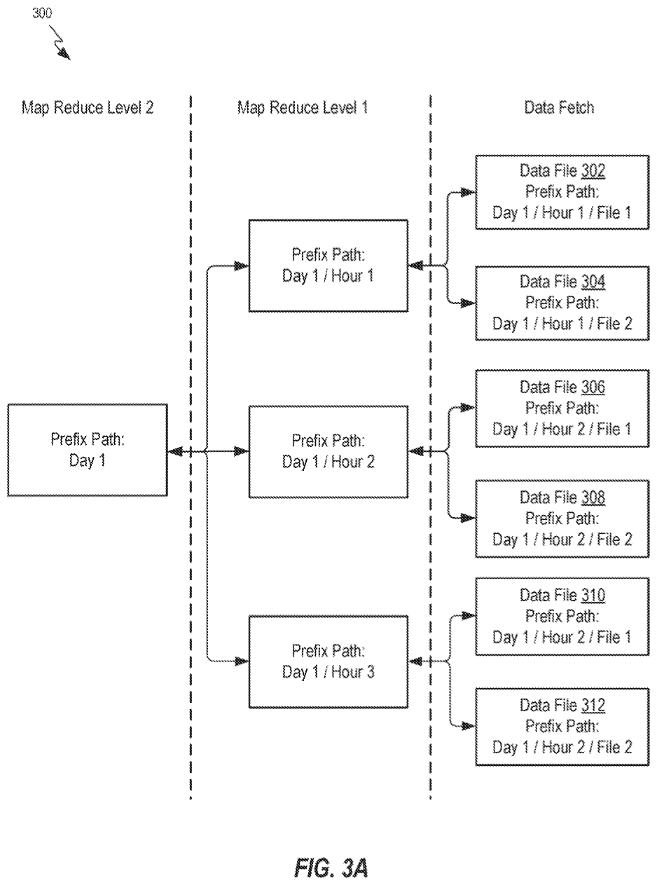

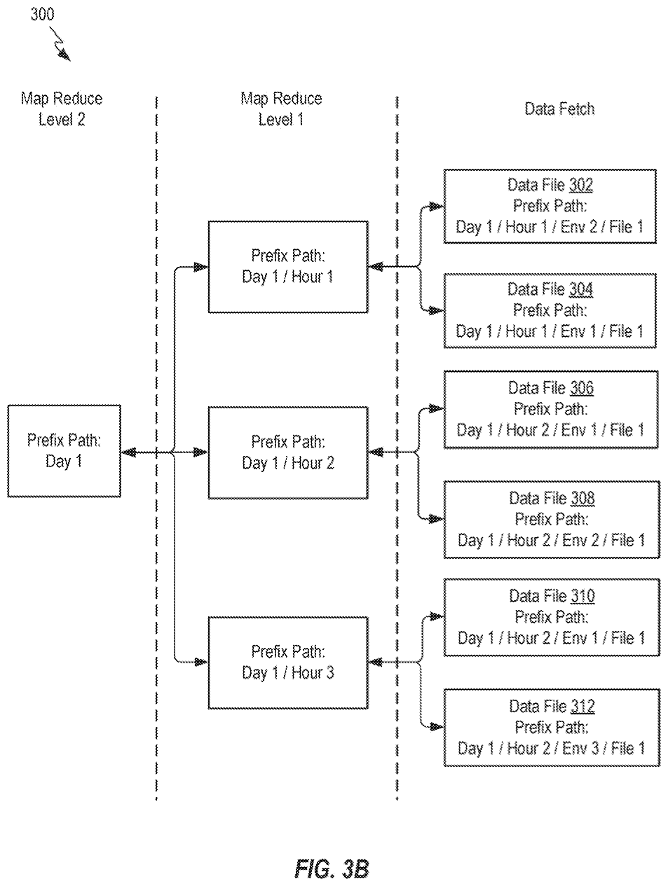

FIG. 3A shows an exemplary graphical representation of a hierarchical log data structure 300 that could be formed and stored by log data storage system 112. In this way, even though log data storage system 112 does not include an index of the log data files, the log data files can maintain a certain amount of organization. Map reduce levels 1 and 2 show how the log data files are organized primarily by log entry time. Exemplary individual data files 302-312 are shown in the data fetch region of FIG. 3A. While only three hours of data are represented in FIG. 3A it should be appreciated that the hierarchical structure can organize the log data files over a much larger period of time. Furthermore, when the stored log data spans multiple days, the hierarchical log data structure can include additional map reduce levels 3 and 4, representing weeks and months, could be added to help further organize the data files. Also, each hour can include more than two data files depending on how rapidly log data is being produced and what a target file size is for log data files. For example, hours in which more logged events occur will tend to include a larger number of data files. The hierarchical structure also helps a series of queries applied to search the log data to run in parallel by targeting different branches of hierarchical data structure 300.

FIG. 3B shows how in some embodiments, data files can be grouped/partitioned based on customer defined query conditions before persisting the log data files to log storage 110. This can greatly reduce the amount of data to be scanned for queries directed to one of the groups/partitions. In this representation, each data file can be associated with only a single type of environment. For example, various ones of computing systems 202 can participate in different environments such as a development environment, a staging environment and a production environment. Env 1 could represent a production environment, Env 2 can represent a development environment and Env 3 can represent a staging environment. By grouping the data files in this manner, queries specifying a specific environment can reduce the number of log data files to be searched by about 66%.

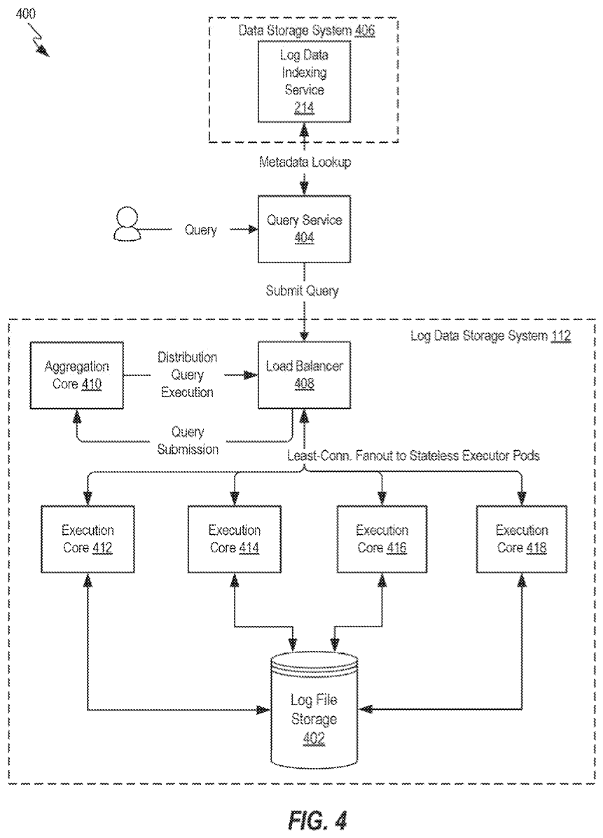

FIG. 4 shows a log data retrieval system 400 for querying log data files stored in log data storage system 112. A user leveraging log data retrieval system 400 is able to retrieve log data stored in log file storage 402 of log data storage system 112 by submitting a query to query service 404 requesting log data meeting a particular set of criteria. Prior to submitting the query to log data storage system 112, the query or at least the limitations associated with the query are transmitted to log data indexing service 214, which runs on and stores metadata within data storage system 406. The metadata is generally stored uncompressed within data storage system 406 in some kind of relational database to facilitate rapid retrieval of any requested metadata. Log data indexing service 214 returns a list of files stored on log data storage system 112 and in some embodiments file locations, containing the requested data. The query can then be updated to search only the identified files for the requested information. In some embodiments, the file location information can be accompanied by an actual or estimated number of records matching the criteria from the submitted query in each file.

After making updates to the query based on the information provided by log data indexing service 214, the query is submitted to load balancer 408 of log data storage system 112. It should be noted that, log data storage system 112 can represent a public cloud storage service such as AWS or Azure or alternatively a private cloud system. Load balancer 408 then submits the query to an aggregation core 410. In some embodiments, load balancer 408 can be implemented using NGINX, an efficient HTTP load balancer. Aggregation core 410 can take the form of a first standard cloud storage compute unit assigned to the query by load balancer 408. Aggregation core 410 receives instructions from the submitted query and prepares instructions for load balancer 408. The instructions can include assignments for each one of execution cores 412-208. While this particular query is depicted as being assigned four execution cores and one aggregation core, it should be appreciated that a larger or smaller number of cores can be assigned based on the urgency of the request. Requests for a large number of queries can also greatly affect the speed at which data is retrieved. In some embodiments a user may be asked to provide an urgency or priority for the request with the knowledge that higher urgency or priority requests will result in higher fees for the data retrieval.

In some embodiments, each execution core receives a query directed toward the same number of log data files. In some embodiments, the assignment of cores can be based on a location of the log data files on log file storage 406. Since log file storage 110 may have the log data files stored in multiple locations or across multiple storage arrays, additional efficiency can be realized by assigning each execution core files that are located in only a subset of the storage locations. In some embodiments, aggregation core 410 may also be leveraged to search for and query one or more of the log data files identified by log data indexing service 214. Because the aggregation and execution cores are able to bypass log data files that don't contain any of the data being searched for, the query can be executed much more quickly and often at a lower cost than a dumb search performed that would have to search all of the log data files. Once the execution cores have completed their queries, that data is sent back to aggregation core 202 for aggregation before the resulting log data is transmitted back to query service 402.

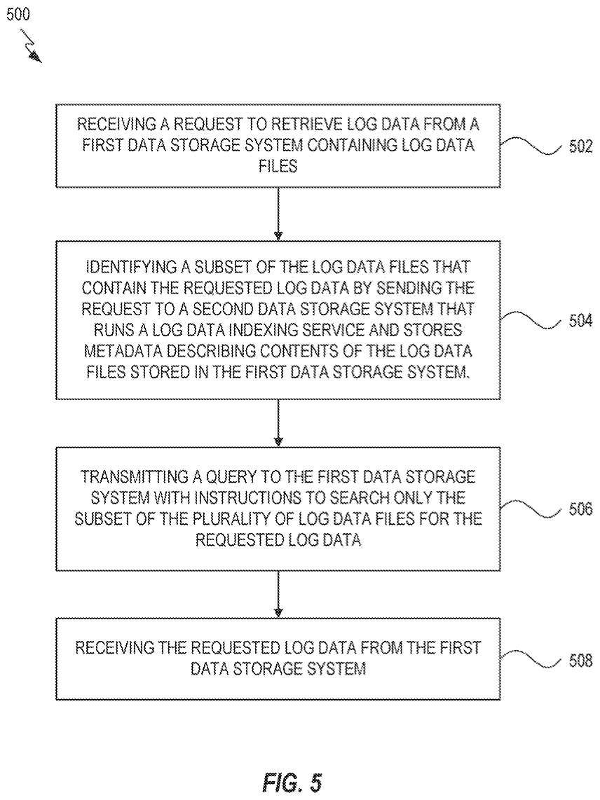

FIG. 5 shows a flow diagram illustrating a process for efficiently querying indexless log data. At step 502 a request to retrieve log data from a first data storage system is received. The first data storage system can contain log data files organized in a hierarchical structure organized by a time of generation of the log data records. The request can specify only specific types of log data be retrieved. The request will also generally target log data occurring over a predetermined period of time. At step 504, a subset of the log data files stored on the first data storage system that corresponds to the request is identified based on particulars of the request. The identification is performed by accessing metadata stored on a second data storage system that is separate and distinct from the first data storage system. In some embodiments, the metadata can be stored in a relational database that allows for rapid access to the metadata. At step 506, a query that includes both the original request parameters and the subset of the plurality of log data files is transmitted to the first data storage system. At step 508, the requested log data is received from the first data storage system.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A non-transitory computer-readable storage medium storing instructions configured to be executed by one or more processors to carry out steps that include:
receiving a request to retrieve log data from a first data storage system containing a plurality of log data files;
identifying a subset of the plurality of log data files that contain the requested log data by sending the request to a second data storage system, separate and distinct from the first data storage system, that runs a log data indexing service and stores metadata describing contents of the plurality of log data files stored in the first data storage system;
transmitting a query to the first data storage system with instructions to search only the subset of the plurality of log data files for the requested log data; and
receiving the requested log data from the first data storage system.

2. The non-transitory computer-readable storage medium of claim 1, wherein the query transmitted to the first data storage system comprises instructions to create a plurality of subqueries for concurrent execution by a plurality of compute units associated with the first data storage system.

3. The non-transitory computer-readable storage medium of claim 2, wherein the plurality of log data files is stored in a hierarchical data structure organized by time of generation.

4. The non-transitory computer-readable storage medium of claim 1, wherein the query comprises instructions specifying how many compute units the first data storage system should apply to the query based on an urgency of the request.

5. The non-transitory computer-readable storage medium of claim 4, wherein the query includes instructions for how to divide the query into sub-queries for assignment to the specified number of compute units.

6. The non-transitory computer-readable storage medium of claim 1, wherein identifying the subset of the plurality of log data files comprises receiving the identification of the subset of the plurality of log data files from the log data indexing service.

7. The non-transitory computer-readable storage medium of claim 1, wherein the metadata comprises file size, time range and URIs where a log data file can be accessed within the first data storage system for each of the plurality of log data files.

8. The non-transitory computer-readable storage medium of claim 1, wherein the metadata is stored by the log data indexing service at the second data storage system prior to storing the log data within the first data storage system.

9. A log data retrieval system, comprising:
one or more processors; and
memory storing one or more programs configured to be executed by the one or more processors, the one or more programs including instructions for:
receiving a request to retrieve log data from a first data storage system containing a plurality of log data files;
identifying a subset of the plurality of log data files that contain the requested log data by sending the request to a second data storage system, separate and distinct from the first data storage system, that runs a log data indexing service and stores metadata describing contents of the plurality of log data files stored in the first data storage system;
transmitting a query to the first data storage system with instructions to search only the subset of the plurality of log data files for the requested log data; and
receiving the requested log data from the first data storage system.

10. The log data retrieval system of claim 9, wherein the query transmitted to the first data storage system comprises instructions to create a plurality of subqueries for concurrent execution by a plurality of compute units associated with the first data storage system.

11. The log data retrieval system of claim 10, wherein the plurality of log data files is stored in a hierarchical data structure organized by time of generation.

12. The log data retrieval system of claim 9, wherein the query comprises instructions specifying how many compute units the first data storage system should apply to the query based on an urgency of the request.

13. The log data retrieval system of claim 12, wherein the query includes instructions for how to divide the query into sub-queries for assignment to the specified number of compute units.

14. The log data retrieval system of claim 9, wherein identifying the subset of the plurality of log data files comprises receiving the identification of the subset of the plurality of log data files from the log data indexing service.

15. The log data retrieval system of claim 9, wherein the metadata comprises file size, time range and URIs where a log data file can be accessed within the first data storage system for each of the plurality of log data files.

16. A method of retrieving data from a log data storage system, the method comprising:
receiving a request to retrieve log data from a first data storage system containing a plurality of log data files;
identifying a subset of the plurality of log data files that contain the requested log data by sending the request to a second data storage system, separate and distinct from the first data storage system, that runs a log data indexing service and stores metadata describing contents of the plurality of log data files stored in the first data storage system;
transmitting a query to the first data storage system with instructions to search only the subset of the plurality of log data files for the requested log data; and
receiving the requested log data from the first data storage system.

17. The method of claim 16, wherein the query transmitted to the first data storage system comprises instructions to create a plurality of subqueries for concurrent execution by a plurality of compute units associated with the first data storage system.

18. The method of claim 17, wherein the plurality of log data files is stored in a hierarchical data structure organized by time of generation.

19. The method of claim 16, wherein the query includes instructions specifying how many compute units the first data storage system should apply to the query based on an urgency of the request.

20. The method of claim 19, wherein the query includes instructions for how to divide the query into sub-queries for assignment to the specified number of compute units.
